(19) United States
(12) Patent Application Publication
(10) Pub. No.: US 2005/0268300 A1
(43) Pub. Date: Dec. 1, 2005

(54) Distributed task scheduler for computing environments

(75) Inventors: Steven D. Lamb, Woodinville, WA (US); Johan Peter Hansen, Bellevue, WA (US)

Correspondence Address: LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 10/846,732

(22) Filed: May 14, 2004

(51) Int. Cl. G06F 9/46

(52) U.S. Cl. 718/100

(57) ABSTRACT

A distributed task scheduling method and system that separates and performs task management and task execution on separate computing devices and distributes task execution over multiple computing devices. The distributed task scheduler includes two-tier architecture having at least one execution host and at least one data broker. The execution hosts handle the tasks and the data broker manages the task schedule. The data broker determines any scheduled tasks that need to be executed. Once an available task is found, the data broker dispenses the scheduled task to an execution host. A timeout period is selected for each assigned task. If the assigned execution host does not report back to the data broker within the timeout period the completion of the assigned task, the data broker is free to assign the task to another execution host to ensure reliable execution of the task.

### TECHNICAL FIELD

The present invention relates in general to task scheduling for computing environments and more particularly to a two-tier distributed task scheduling method and system that separates and performs task management and task execution on separate computing devices and distributes the task execution over multiple computing devices to achieve scalability and reliability in scheduled task execution.

### BACKGROUND OF THE INVENTION

Task scheduling is an important feature in computing environments. Tasks to be executed may include network requests, dynamic link libraries, the scheduled processing of data, and other tasks such as periodic hard drive maintenance and compression, hard drive defragmentation, and the cleanup of old files. Scheduled task systems are designed to automatically execute a predetermined process at a set time, at a set interval, or both. Traditionally, these systems have been implemented as an application that maintains a list of tasks to be executed and the time at which each task is to be executed. Examples of such scheduled task systems include the Task Scheduler in the Microsoft® Windows® XP operating system, or the CRON daemon included with most Unix® systems.

Current scheduled task systems and designed to operate in a computer environment having a single computer. This means that the list of tasks (or scheduling data) is stored locally and on the same computer that executes the tasks. While these systems work well in this single computer environment, these systems have significant drawbacks when applied to environments where reliability and scalability are paramount. One drawback is that these systems are not scalable. For example, if there are many tasks scheduled to be run at or near the same time, the single host computer may quickly become overburdened or low on resources, and as result some of the tasks may not execute correctly. Another drawback is that the systems are not totally reliable in situations where the task absolutely must be executed. For example, if the single computer hosting the scheduling application fails or is turned off during the time a task is scheduled to run, that task will not be executed. This can have serious consequences in a mission-critical environment such as such as a data center or a distributed network of servers where the task must be executed.

Another example of a mission-critical environment is online gaming. Online gaming is an environment where several people compete in a game over a computer network (typically the Internet). Many activities in an online game require a process to be executed outside the context of user activity, on a scheduled, independent basis. By way of example, these activities may include round progression of a tournament to take place at a specified time and reducing a rank of players in statistics if a player has not participated in the game for a long period. The game is an ongoing process, and it is critical that the tasks necessary to keep the game going are executed in a reliable manner for the competition to continue uninterrupted and on schedule. In addition, because the number of players may fluctuate, scalability of the task scheduler becomes an important factor. Accordingly, there exists a need for a task scheduler for a computing environment that provides scalable and absolutely reliable execution of tasks on a scheduled basis.

### SUMMARY OF THE INVENTION

The invention disclosed herein includes a distributed task scheduling method and system that separates task management from task execution. In particular, task management and task execution are performed on separate computing devices. In addition, task execution is distributed over multiple computing devices. The task management is performed by at least one data broker while the task execution is performed by a plurality of execution hosts.

The distributed task scheduler achieves scalability by having a plurality of execution hosts capable of executing tasks, all under the direction of at least one data broker, such that a task is only executed by a single execution host at a time. Reliability is achieved by having a multiplicity of execution hosts so that if one execution host fails another host can ensure the task is executed. A timeout period is provided for each task, such that an execution host is given the timeout period to execute the task and notify the data broker of the task completion. If the execution host does not or cannot execute the task within the timeout period, the data broker is free to give the task to a different execution host.

The distributed task scheduler uses a data broker and a plurality of execution hosts to execute tasks in a computing environment. A scheduled task list, which includes a list of scheduled tasks to be executed, is stored on the data broker. The data broker dispenses or gives out tasks from the scheduled task to the plurality of execution hosts for execution of the task. The data broker and each of the plurality of execution hosts are located on separate computing devices. The scheduled task list contains tasks and may also contain a task execution timetable representing a scheduled execution time associated with each of the tasks.

The distributed task scheduler includes a two-tier architecture that distributes task management and task execution over a plurality of computing machines. Each tier has at least two separate computing devices. The data management tier having at least one data broker is used to determine whether any scheduled tasks need to be executed at a current time. This is accomplished by examining the scheduled tasks list and determining whether tasks needing to be executed meet certain availability criteria. If an available task is found, the data management tier assigns the scheduled task needing to be run to the task execution tier. Once a task has been given out to the data execution tier, the task is executed on the data execution tier using an execution host. Once the task has been executed the execution host reports to the data broker that the task execution has been completed.

If a task is not found by the data broker, the execution host notes the check-back time that was received from the data broker and then sleeps for some configurable amount of time. A determination then is made as to whether a wake-up time is before the check-back time. If so, then the host checks back with the data broker for a new task at the wake-up time. If the wake-up time is after the check-back time, the host awakens from sleep at the check-back time and makes a new task request to the data broker.

The data broker examines the schedule task list for any available task. A task is defined as available to be executed if the task meets the following criteria: (1) the next execution time for the task is less than or equal to the current time; (2) the task is not marked as completed; and either (3a) the execution host is blank; or (3b) a timeout period has expired without the execution host marking the job as completed. If these criteria are met, then a task is available for execution. Using this approach, multiple execution hosts may be assigned to execute scheduled tasks. If any one of the execution hosts fails unexpectedly, the task will be attempted from another host. By recording the host identifier with the task, the data broker can ensure only one execution host attempts to execute a task at any given time. The data broker should be a transactional data broker, in order to ensure that an update to a given task can only happen by a single thread and a single process on that data broker.

### BRIEF DESCRIPTION OF THE DRAWINGS

The present invention can be further understood by reference to the following description and attached drawings that illustrate aspects of the invention. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 is a block diagram illustrating an overview of the distributed task scheduler.

FIG. 2 illustrates an example of a suitable computing system environment in which the distributed task scheduler shown in FIG. 1 may be implemented.

FIG. 3 is a flow diagram illustrating the general operation of the distributed task scheduler shown in FIG. 1.

FIG. 4 is a block/flow diagram illustrating the interaction between the execution host and the data broker of the distributed task scheduler shown in FIGS. 1 and 3.

FIG. 5 is a flow diagram illustrating the detailed operation of the execution host shown in FIG. 4.

FIG. 6 is a flow diagram illustrating the detailed operation of the data broker shown in FIG. 4.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Current scheduled task systems are designed to operate on a single computer. This can cause problems if the computer fails, because the tasks needing to be executed will not be executed until the computer starts working again. In addition, the single computer scheduled task system can quickly become overworked if a large number of tasks need to be executed at or near the same time.

The distributed task scheduler disclosed herein overcomes these problems and more by separating and distributing the task management and execution over a plurality of computing devices. A two-tier architecture includes at least one execution host and at least one data broker residing on separate computing devices. The execution hosts actually handle the tasks and the data broker manages the task schedule. A single list of tasks to be executed is shared between each of the devices, with special provisions made to ensure tasks are executed as close to the scheduled time as possible, even in the case of catastrophic failure in one or more of the devices. As a result, the distributed task scheduler provides a reliable and scalable system for scheduled task execution.

II. General Overview

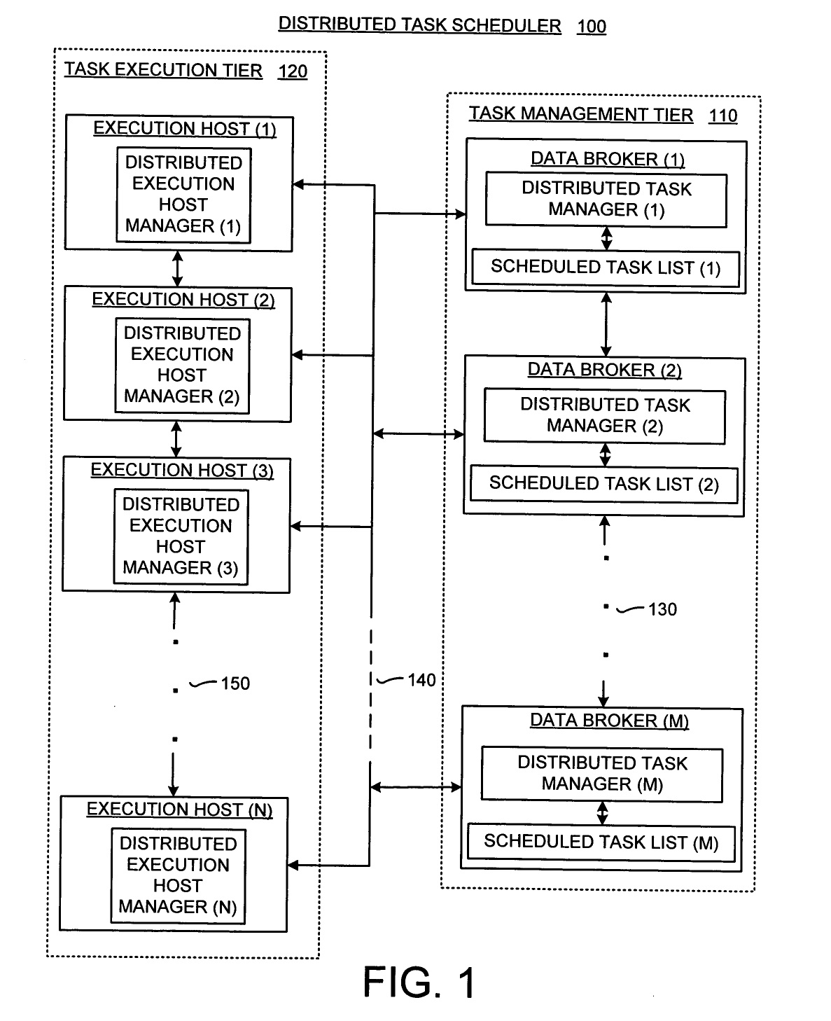

The distributed task scheduler facilitates the scalable and reliable execution of tasks in a computing environment. FIG. 1 is a block diagram illustrating an overview of the distributed task scheduler 100. The scheduler 100 uses a two-tier architecture that separates the data containing the scheduled task lists from the execution engine. An advantage of the two-tier architecture is that if any one of the execution machines fails, then any other execution machine can take over the execution of a task.

The two-tier architecture of the distributed task scheduler 100 includes a task management tier 110 and a task execution tier 120. The task management tier 110 includes one or more data broker machines. The data broker machines are shown in FIG. 1 as data broker (1), data broker (2), and so forth until data broker (M). The ellipses 130 and 140 indicate that there may be data brokers that are not illustrated. Thus, there are M number of data brokers. In addition, each data broker contains corresponding distributed task managers (1) to (M) and scheduled task lists (1) to (M). The scheduled task lists store a list of tasks to be executed and an execution time for each task. The distributed task managers oversee which execution host, if any, is current executing a task and the brokering of tasks on the scheduled task lists to the execution hosts.

In an exemplary implementation, M=2 and data broker (1) is the master data broker while data broker (2) is a back-up data broker. In this implementation, only one of the data brokers is operational at a time. The master data broker is the only data broker using the scheduled task list (1) and the distributed task manager (1) to give out tasks to the execution hosts. In case of failure of the master data broker, the back-up data broker becomes the master data broker. In order to facilitate a smooth transition in case of failure, the scheduled task list (2) of the back-up data broker is a copy of the scheduled task list (1) of the master data broker.

In alternate implementations, each of the data brokers (1) to (M) is a master data broker has master separate scheduled task lists (1) to (M) that are different from each other. In this case, the respective distributed task managers (1) to (M) dole out tasks to the execution hosts independently of each other. In addition, the execution hosts (discussed below) request tasks from each of the master data brokers (1) to (M) in a random manner or a sequential manner. Other implementations also are possible, such as having multiple pairs of data brokers, where each pair is a master data broker and a back-up data broker, as described above. In this implementation, each data broker pair uses a single scheduled task list to give out tasks to the execution hosts.

The task execution tier 120 includes one or more execution hosts. The execution hosts are shown in FIG. 1 as execution host (1), execution host (2), execution host (3) and so forth until execution host (N). The ellipses 140 and 150 indicate that there may be execution hosts that are not illustrated. There are N number of execution hosts, with each execution host containing a distributed execution host manager (1) to (N). The execution hosts (1) to (N) are a set of servers that handle the actual execution of tasks. In addition, the execution hosts (1) to (N) handle requests to schedule new tasks, remove existing tasks, and query the data brokers about the list of tasks to be executed. The advantage of having a plurality of execution hosts is that even if one of the execution hosts fails, other execution hosts can execute the task instead, thereby ensuring that the task will be executed. Another advantage to having multiple execution hosts is scalability. If one of the execution hosts reaches its maximum capacity, any of the other execution hosts can receive the extra tasks needing to be executed and perform the execution.

III. Exemplary Operating Environment

The distributed task scheduler 100 is designed to operate in a computing environment and on a computing device, such as the data brokers (1) to (M) and the execution hosts (1) to (N), shown in FIG. 1. The computing environment in which the distributed task scheduler 100 operates will now be discussed. The following discussion is intended to provide a brief, general description of a suitable computing environment in which the distributed task scheduler 100 may be implemented.

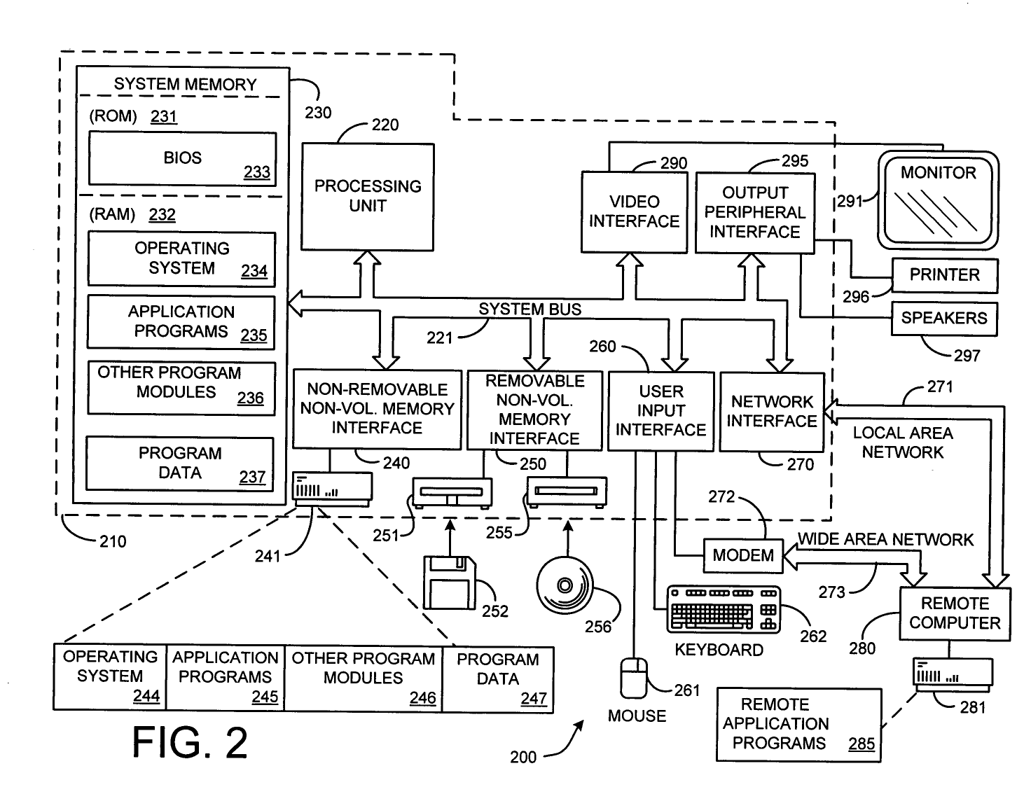

FIG. 2 illustrates an example of a suitable computing system environment in which the distributed task scheduler 100 shown in FIG. 1 may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The distributed task scheduler is operational with numerous other general purpose or special purpose computing system environments or configurations. Examples of well known computing systems, environments, and/or configurations that may be suitable for use with the distributed task scheduler include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The distributed task scheduler may be described in the general context of computer-executable instructions, such as program modules, being executed by a computer. Generally, program modules include routines, programs, objects, components, data structures, etc., that perform particular tasks or implement particular abstract data types. The distributed task scheduler may also be practiced in distributed computing environments where tasks are performed by remote processing devices that are linked through a communications network. In a distributed computing environment, program modules may be located in both local and remote computer storage media including memory storage devices. With reference to FIG. 2, an exemplary system for implementing the distributed task scheduler includes a general-purpose computing device in the form of a computer 210 (the data brokers (1) to (M) and the execution hosts (1) to (N) shown in FIG. 1 are examples of the computer 210).

Components of the computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 210 typically includes a variety of computer readable media. Computer readable media can be any available media that can be accessed by the computer 210 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 210. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within the computer 210, such as during start-up, is typically stored in ROM 231. RAM 232 typically contains data and/or program modules that are immediately accessible to and/or presently being operated on by processing unit 220. By way of example, and not limitation, FIG. 2 illustrates an operating system 234, application programs 235, other program modules 236, and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, the hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 220 through a user input interface 260 that is coupled to the system bus 221, but may be connected by other interface and bus structures, such as, for example, a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

IV. Operational Overview

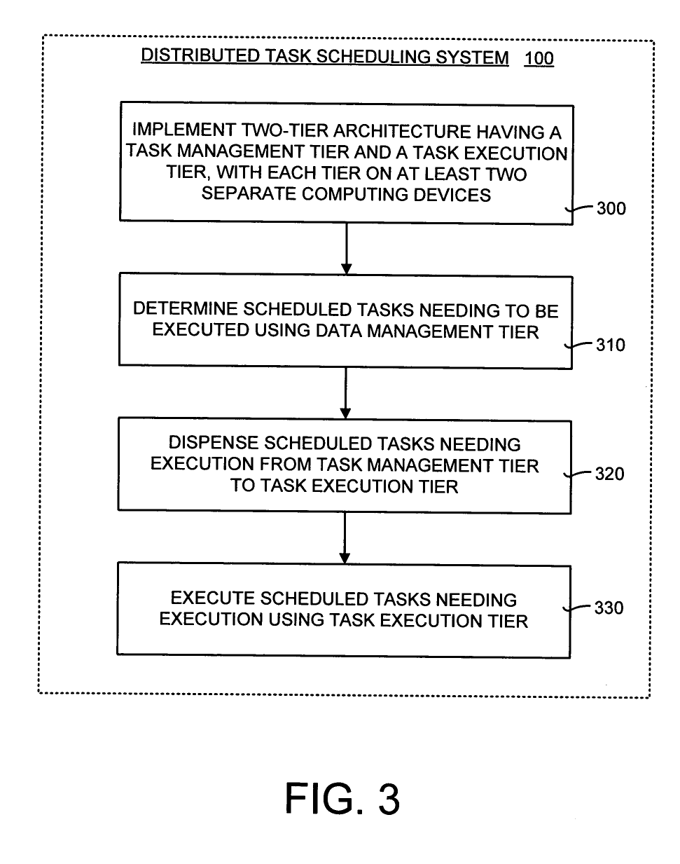

The distributed task scheduler 100 includes a two-tier architecture that distributes task management and task execution over a plurality of computing machines. FIG. 3 is a flow diagram illustrating the general operation of the distributed task scheduler 100 shown in FIG. 1. The distributed task scheduler 100 implements a two-tier architecture having a task management tier and a task execution tier (box 300). Each tier has at least two separate computing devices. Once the two-tier architecture is implemented, the distributed task scheduler 100 uses the data management tier to determine any scheduled tasks that need to be executed (box 310). As described in detail below, this is achieved by examining the scheduled tasks list and determining whether tasks needing to be executed meet certain availability criteria. The scheduled task list contains tasks. In addition, the scheduled task list may include a task execution timetable, which contains a scheduled execution time associated with each of the tasks. In alternate implementations, it is possible to have tasks without times such that the scheduled task list does not contain a task execution timetable. In this case, the scheduled task list is a simple queue of tasks to be executed as soon as possible.

Once an available task is found, the distributed task scheduler 100 dispenses the scheduled task needing to be run from the task management tier to the task execution tier (box 320). Typically, this is achieved by having the data broker send the task to an execution host. It is important to note that each task is sent to only one execution host. This means that for a given task, only one execution host is responsible for executing that task. As explained in detail below, if that execution host fails to execute the task within a prescribed time period, then the execution host is assumed to have failed and the task is given to a different execution host. However, at all times only one execution host is responsible for executing a given task.

Once a task has been given out to the data execution tier, the task is executed on the data execution tier (box 330). Typically, this involves an execution host to whom the task has been given executing the task. As explained in greater detail below, once the task has been executed the execution host reports to the data broker that the task execution has been completed.

V. Operational Details

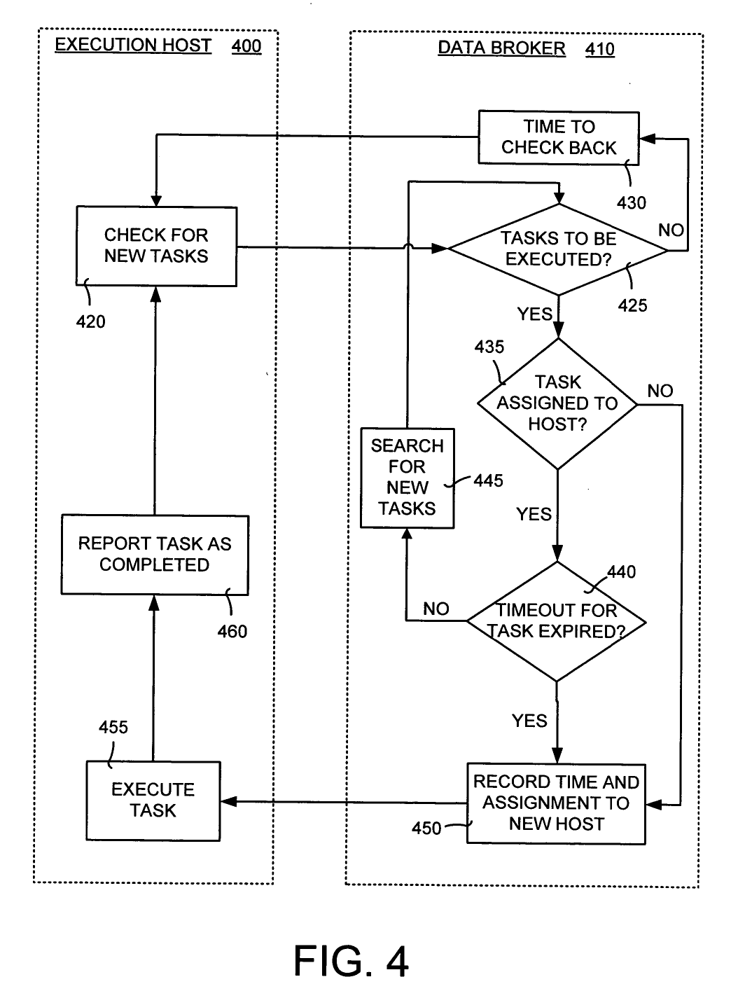

The operational details of the distributed task scheduler 100 will now be discussed. FIG. 4 is a block/flow diagram illustrating the interaction between the execution host and the data broker of the distributed task scheduler shown in FIGS. 1 and 3. As noted above, the execution host are part of the data execution tier and the data brokers are part of the data management tier. Referring to FIG. 4, for simplicity only a single execution host 400 and a single data broker 410 are shown. However, it should be noted that typically more than one execution host 400 and data broker 410 will be used, depending on the specific implementation.

The execution host 400 and the data broker 410 are physically separate computing devices. The execution host 400 is a computing device that handles the requests, reporting, and execution of tasks. The data broker 410 is a computing device that stores the list of tasks to be executed, the time of scheduled execution, and the brokering of tasks to the execution host 400. In addition, the data broker 410 keeps track of which tasks the execution host 400 has been given, and whether a task has been completed.

When the execution host 400 is ready (such as after start-up or waking up from a sleep), a request is made to the data broker 410 for new tasks (box 420). Upon receiving this request, the data broker 410 checks its scheduled task list (not shown) to determine whether there are any new tasks needing to be executed (box 425). If there are no tasks needing to be executed at the current time, then the data broker 410 informs the execution hosts to check back again at a specific amount of time in the future (box 430). This check-back time is based on the task execution timetable kept in the scheduled task list.

If there is a task needing to be executed at the current time, the data broker 410 next determines whether the task is already assigned to a host (box 435). If the task already is assigned, then the data broker 410 determines whether a timeout period for the task has expired (box 440). The timeout period is the time allotted by the data broker 410 in which the task must be executed by the execution host 400. If a task is given to a execution host 400 and the execution host 400 has not reported the task as completed within the timeout period, the data broker 410 assumes the execution host 400 has failed. In this case, the task still needs to be executed and the data broker 410 assigns the task to another execution host for execution. In this way, the distributed task scheduler ensures reliable task execution.

If the timeout period for the task has not expired, the data broker 410 searches its scheduled task list for any other new tasks (box 445). If the timeout period for the task has expired, then the data broker 410 records which execution host 400 was given the task and the time at which the task was given out (box 450). Similarly, if the determination of whether the task is assigned to a host (box 435) is negative, the data broker 410 assigns the task to the execution host 400 and records the assignment and the time. The recordation of the time is important because once the task is given to the execution host 400 and the timeout period begins.

When the execution host 400 receives a new task from the data broker 410, the execution host 400 executes the task (box 455). Next, the execution host 400 reports to the data broker 410 that the task has been completed (box 460). Once a task is completed the execution host 400 can check back with the data broker 410 for an additional task (box 420).

It should be noted that one execution host 400 can execute a plurality of task simultaneously. The number of tasks that can be simultaneously executed is dependent (at least in part) on the current state of computer processor technology. In one tested implementation, each execution host is capable of executing approximately 25 tasks simultaneously. In practice, multiple threads are sent out from the execution host 400 to obtain new tasks. Thus, one execution host 400 may have multiple threads that are all picking up tasks from the data broker 410. It can be seen, therefore, that FIG. 4 can represent a process that is occurring simultaneously over a plurality of threads between one or more of the execution host 400 and one or more of the data brokers 410.

Execution Host

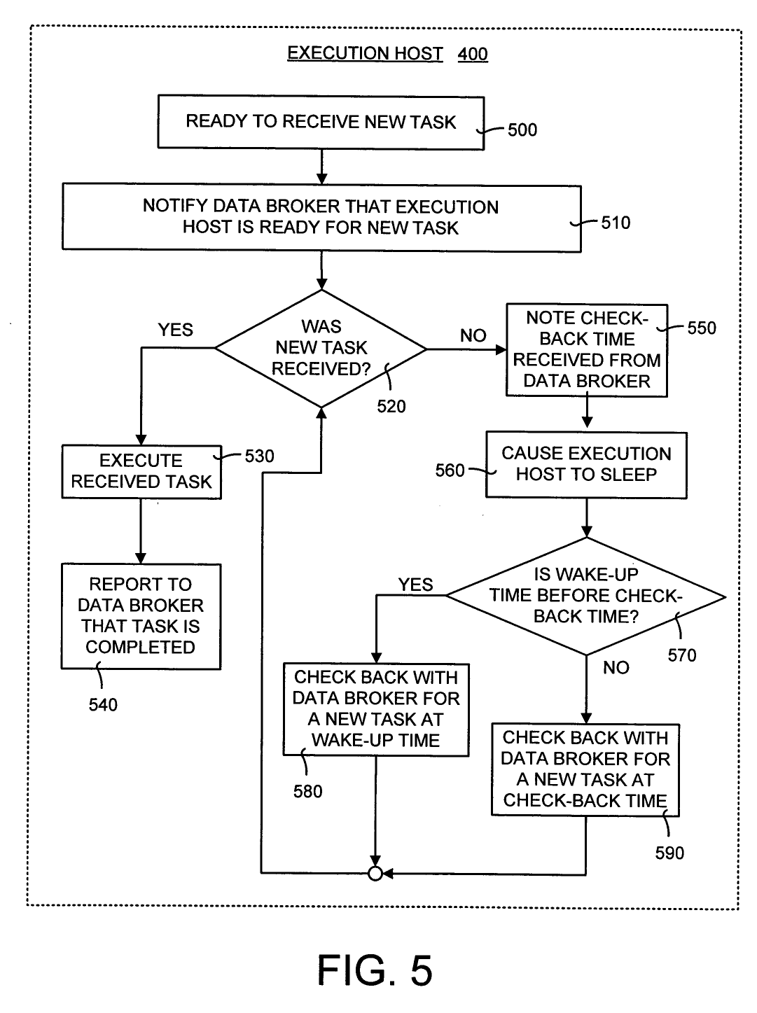

FIG. 5 is a flow diagram illustrating the detailed operation of the execution host 400 shown in FIG. 4. Any number of computing devices can be execution hosts. In general, the execution host 400 obtains a task, executes the task, and notifies the data broker 410 when the task is completed.

More specifically, the operation begins as the execution host 400 becomes available for a new task (box 500). This can occur when the execution host 400 starts up, wakes up from a sleep, or has completed the task at hand. The execution host 400 then notifies the data broker 410 that the host 400 is available for a new task (box 510). It should be noted that each execution host 400 does not have a complete list of tasks. Instead, each execution host 400 (or more correctly, each thread of the execution host 400) obtains one task at a time, completes that task, and then asks for another task by notifying the data broker 410 that the task is completed.

The execution host 400 then determines whether a new task was received from the data broker 410 (box 520). If a task was received, the host 400 executes the received task (box 530). In a particular implementation, tasks are implemented as dynamic link libraries (DLLs) that expose a pre-defined interface. However, a task can be any set of executable instructions. As soon as the host 400 is finished executing the received task, the host 400 reports to the data broker 410 that the task is completed (box 540). The host 400 then ask for a new task (box 510).

Each task has associated with it a timeout period. If the host 400 does not report back to the data broker 410 with the timeout period that the task has been completed, the data broker 410 is free to assign the task to a different host. In other words, an execution host 400 has an exclusive lock or monopoly on the task during the timeout period. Once the timeout period has expired, that monopoly is broken and the task can be given to a different host for execution. If the host 400 fails or some other bad thing happens to the host 400 such that is cannot report back to the data broker 410 that the task was completed within the time specified, then the data broker 410 puts the task back into the pool of tasks and reassigns the task to a different host.

If a task is not received from the data broker 410, the execution host 400 notes the check-back time that was received from the data broker 410 (box 550). The check-back time is the time when a certain task is due to be executed, and thus will become available. The execution host 400 then sleeps for some configurable amount of time (box 560). In a preferred implementation, the sleep time is approximately one minute. This gives the data broker 410 relief so that the execution hosts are not constantly bothering the data broker 410.

A determination then is made as to whether a wake-up time (the time that the host 400 “awakens” from its sleep) is before the check-back time (box 570). If so, then host 400 makes a request to (“checks back with”) the data broker 410 for a new task at the wake-up time (box 580). In other words, even if the check-back time is an hour later, the host 400 will sleep for until the wake-up time and then make a request to the data broker 400, long before the check-back time. If the wake-up time is after the check-back time, the host 400 will awaken from sleep at the check-back time (and before the wake-up time) to make a request to the data broker 410 for a new task (box 590).

Data Broker

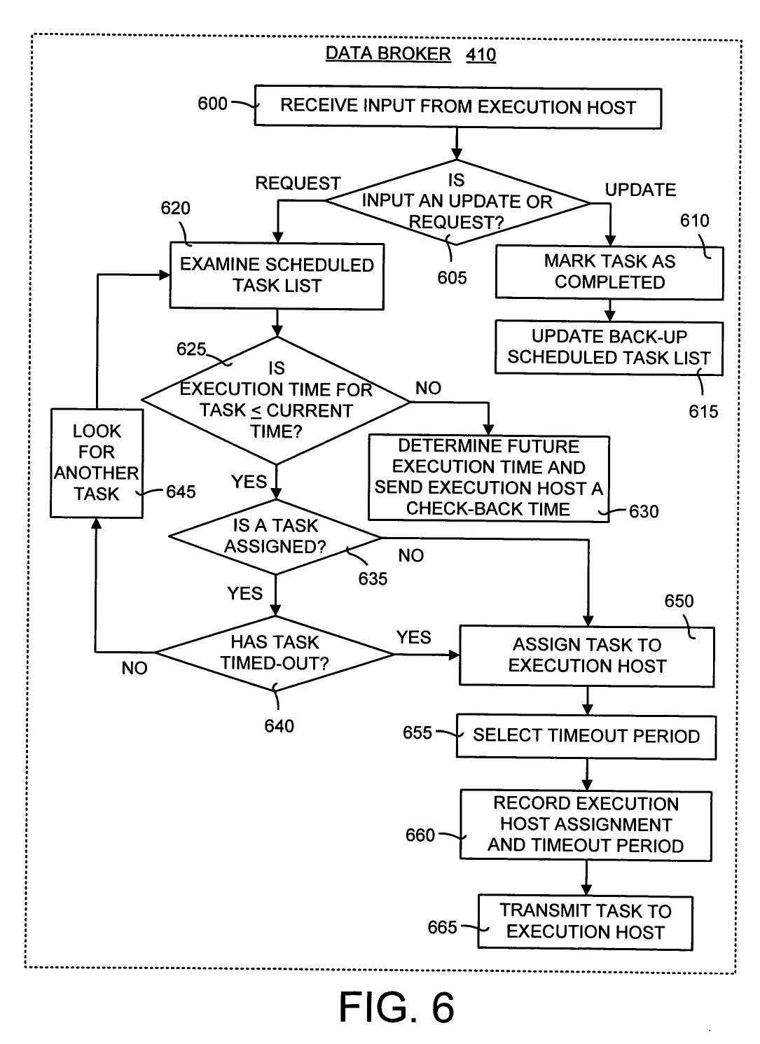

FIG. 6 is a flow diagram illustrating the detailed operation of the data broker 410 shown in FIG. 4. In general, the data broker 410 determines one or more tasks that are due to be executed, records the current time and to whom the task was assigned, and provides the task information to the execution host 400 to execute. Once the execution host 400 has completed execution of the task, it notifies the data broker 410, which marks the task as completed, reschedules the task for the next execution time, or both.

In particular, the operation of the data broker 410 begins by receiving input from an execution host (box 600). A determination then is made as to whether the input is an update or a request (box 605). If the input is an update, the data broker 410 mark the task as completed by the execution host providing the update (box 610). Next, the data broker 410 updates any back-up scheduled task lists on back-up data brokers (box 615).

If the input is a request, the data broker examines the schedule task list for any available task (box 620). In general, a task is defined as available to be executed if the task meets the following criteria: (1) the next execution time for the task is less than or equal to the current time; (2) the task is not marked as completed; and either (3a) the execution host is blank; or (3b) a timeout period has expired without the execution host marking the job as completed. If these criteria are met, then a task is available for execution.

In particular, the data broker 410 determines whether an execution time for a task is less than or equal to the current time (box 625). If not, then the data broker 410 notes the execution time, calculates the check-back time, and sends the requesting execution host the check-back time (box 630). As explained above, the execution host 400 uses the check-back time to determine when to make another request to the data broker 410.

If the execution time is less than or equal to the current time, the data broker 410 makes a further determination as to whether the task is assigned (box 635). If the task is assigned, then the data broker 410 makes a determination whether the task has timed-out (box 640). In other words, has the timeout period expired without the execution host 400 reporting back to the data broker 410 that the task has been executed. If the task has not timed-out, then the data broker 410 searches the scheduled task list for another task (box 645).

If either the task is not assigned (box 635) or the task has timed-out (box 640), the data broker 410 marks the task as available for execution and assigns the task to the execution host 400 (box 650). Next, a timeout period is selected (box 655). In one implementation, the timeout period is a globally configured timeout period valid for all tasks. In a preferred implementation, the timeout period is dependent on the duration of the task. For example, a task having a short duration (such as a “ping” to a network server) would have an associated short timeout period, while a task having a longer duration (such as defragmenting a large-capacity hard drive) would have an associated longer timeout period. The assignment of the task to the execution host is recorded by the data broker along with the current time and the timeout period associated with the task (box 660). In a preferred implementation, a unique identifier of the execution host 400 (such as the computer's DNS name, IP address, MAC address, etc.) is used to record the task assignment. The task then is transmitted to the assigned execution host (box 665). Once the execution host 400 has completed execution of the task, it notifies the data broker 410, which marks the task as completed, reschedules the task for the next execution time, or both.

Using this approach, multiple execution hosts may be assigned to execute scheduled tasks. If any one of the execution hosts fails unexpectedly, the task will be attempted from another host. By recording the host identifier with the task, the data broker 410 can ensure only one execution host attempts to execute a task at any given time. If the data broker 410 does not receive a notification of completion from the host 400 before a timeout period expires, the data broker 410 assumes that the host 400 has failed unexpectedly and reassigns the task to a different host.

The data broker 410 preferably is a standard database management system (such as Structured Query Language (SQL)). This means that the data broker 410 can be backed up and can use data replication or similar technology to provide redundancy. In addition, the data broker 410 has a redundancy of the scheduled task list. The key thing is that there is only one master scheduled task list at a time. If the master fails, then a backup can be used and become the master.

The data broker 410 should be a transactional data broker. The data broker 410 should be able to guarantee that an update to a given task can only happen by a single thread, a single process on that data broker 410. The record cannot be overwritten by anyone else. And, if something fails during the update of the process of that task, the data broker 410 should make sure that everything is rolled back to the point at which it was before the transaction began. These types of transactions are called atomic transactions. Atomic is a database term meaning that the transaction is all or nothing. Either everything is successfully updated for nothing is updated.

The transactional data broker should also follow ACID rules. ACID is a database acronym standing for Atomic, Consistent, Isolated and Durable. A consistent transaction is one that leaves data in a consistent state, such that the data does not contradict each other. An isolated transaction is one that cannot be viewed by another transaction before it is committed. In other words, the transaction cannot be viewed in its transitional state. A durable transaction means that changes due to a transaction should be stored in a stable storage and should be recoverable in case of system failure. Any data broker that fits this ACID transactional criteria will work.

In a preferred implementation the data broker is a SQL server that is also an ACID transactional data broker. The scheduled task list of tasks to be executed is stored and owned by the central SQL server. When an execution host engine is ready for a task (i.e. wakes up or has completed the task at hand), the host goes to the SQL server and asks for a task. If the task is available, then the SQL server tracks that it gave this task to a specific execution host. The SQL server should do this in a transactional nature make sure that the exact same task is not given to another host. That is why the SQL server should be a transactional database.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

1. A method for executing tasks in a computing environment having at least one data broker and a plurality of execution hosts, comprising:
storing on the data broker a list of scheduled tasks to be executed, wherein the data broker is located on a first computing device;
providing a plurality of execution hosts, whereby each execution host is located on a plurality of different computing devices that are separate from the first computing device; and
using the data broker to distribute the tasks from the scheduled task list for execution by the plurality of execution hosts.

2. The method as set forth in claim 1, wherein the scheduled task list comprises tasks.

3. The method as set forth in claim 2, wherein the scheduled task list further comprises a task execution timetable representing a scheduled execution time associated with each of the tasks.

4. The method as set forth in claim 2, further comprising making a request for a new task from one of the plurality of execution hosts to the data broker.

5. The method as set forth in claim 4, further comprising:
determining that no new tasks are available; and
providing a check-back time from the data broker to the requesting execution host representing a time at which another request should be made.

6. The method as set forth in claim 5, further comprising calculating the check-back time using the task execution timetable.

7. The method as set forth in claim 4, further comprising:
determining that a new task is available because an execution time for the new task is less than or equal to a current time; and
determining whether the new task is assigned to one of the plurality of execution hosts.

8. The method as set forth in claim 7, further comprising:
determining that the new task is assigned;
determining whether a time-out period for the assigned new task has expired; and
reassigning the new task if the time-out period has expired.

9. The method as set forth in claim 8, wherein the time-out period is a time allotted by the data broker in which a task is to executed by an execution host.

10. The method as set forth in claim 1, wherein the computing environment contains a plurality of data brokers, and further comprising:
designating each of the plurality of data brokers as a master data broker; and
causing the plurality of execution hosts to request task from each of the plurality of data brokers.

11. The method as set forth in claim 10, wherein causing the plurality of execution hosts to request task from each of the plurality of data brokers is performed in a random manner.

12. The method as set forth in claim 10, wherein causing the plurality of execution hosts to request task from each of the plurality of data brokers is performed in a sequential manner.

13. The method as set forth in claim 1, further comprising:
recording an assignment of a task to one of the plurality of execution hosts; and
recording a time the assignment was made.

14. The method as set forth in claim 13, further comprising:
executing the assigned task on the assigned execution host; and
reporting the execution of the assigned task to the data broker.

15. A computer-readable medium having computer-executable instructions for performing the method recited in claim 1.

16. A computer-implemented method for managing and executing scheduled tasks in a computing environment, comprising:
implementing a two-tier architecture having task management tier and a task execution tier;
determining which of the scheduled tasks need to be executed using the data management tier;
dispensing the scheduled tasks needing to be executed from the task management tier to the task execution tier; and
executing the scheduled tasks needing to be executed using the task execution tier.

17. The computer-implemented method of claim 16, wherein the task management tier includes at least one data broker and the task execution tier includes at least one execution host.

18. The computer-implemented method of claim 17, further comprising using the at least one execution host to notify the at least one data broker that the at least one execution host is ready to execute a new task.

19. The computer-implemented method of claim 18, further comprising determining that the at least one execution host is ready to receive the new task after the at least one execution host does at least one of the following: (a) wakes up from a sleep; (b) starts up; (c) has completed an old task.

20. The computer-implemented method of claim 18, further comprising:
receiving a new task from the at least one data broker;
executing the new task on the at least one execution host; and
reporting to the at least one data broker that the new task has been executed.

21. The computer-implemented method of claim 18, further comprising receiving a check-back time from the at least one data broker stating that a new task will be available at the check-back time.

22. The computer-implemented method of claim 21, further comprising:
causing the at least one execution host to sleep; and
determining whether a wake-up time for the at least one execution host is before the check-back time.

23. The computer-implemented method of claim 22, further comprising:
checking back with the at least one data broker for a new task at the wake-up time if the wake-up time is before the check-back time; and
checking back with the at least one data broker for a new task at the check-back time if the check-back time is before the wake-up time.

24. The computer-implemented method of claim 17, further comprising:
maintaining a back-up data broker and a master data broker at the task management tier; and
maintaining a master scheduled task list on the master data broker and a back-up scheduled task list on the back-up data broker; and
updating the back-up scheduled task list as the master scheduled task list is updated such that the master scheduled task list and the back-up scheduled task list are copies of each other.

25. The computer-implemented method of claim 24, wherein only the master data broker is actively dispensing the scheduled task needing to be executed to the at least one execution host.

26. The computer-implemented method of claim 17, further comprising using the at least one data broker to determine whether any one of the scheduled tasks are available for dispensing to the at least one execution host after a request for a new task from the at least one execution host to the at least one data broker.

27. The computer-implemented method of claim 26, wherein determining availability further comprises:
comparing an execution time for a task to a current time;
determining that the execution time is greater than the current time; and
transmitting a check-back time from the data broker to the execution host.

28. The computer-implemented method of claim 26, wherein determining availability further comprises:
determining that the execution time is less than or equal to the current time; and
determining whether the task is assigned to one of the at least one execution host.

29. The computer-implemented method of claim 28, further comprising:
determining that the task has been assigned; and
determining whether a timeout period has expired.

30. The computer-implemented method of claim 29, further comprising assigning the task to a different execution host if the timeout period has expired.

31. The computer-implemented method of claim 26, wherein the at least one execution host contains a plurality of processing threads and is capable of executing a scheduled task on each one of the plurality of processing threads.

32. The computer-implemented method of claim 17, further comprising:
selecting a timeout period representing a time in which a task must be executed by an execution host assigned to execute the task; and
notifying the assigned execution host of the timeout period such that the task will be reassigned to another execution host if the assigned execution host does not report back to the data broker within the timeout period that the task has been executed

33. One or more computer-readable media having computer-readable instructions thereon which, when executed by one or more processors, cause the one or more processors to implement the computer-implement method of claim 16.

34. A distributed task scheduling process for processing and executing tasks on plurality of computing devices, comprising:
providing a data broker on a first computing device for management of the tasks;
providing plurality of execution hosts each residing its own separate computing devices;
determining an available task ready for execution using the data broker and availability criteria;
assigning available tasks to the plurality of execution hosts such that the process of executing the available tasks is distributed among each of the plurality of execution hosts;
using the data broker to track the assignments of available tasks to the plurality of execution hosts such that the data broker keeps track the task assignments for each of the plurality of execution hosts; and
causing each of the plurality of execution hosts to notify the data broker when a task has been completed.

35. The distributed task scheduling process as set forth in claim 34, further comprising updating a scheduled task list based on the notification.

36. The distributed task scheduling process as set forth in claim 34, wherein the data broker is an ACID transactional data broker.
